(19) United States
(12) Patent Application Publication
(10) Pub. No.: US 2021/0086851 A1
(43) Pub. Date: Mar. 25, 2021

(54) TURBINE FRACTURING SEMI-TRAILER

(71) Applicant: YANTAI JEREH PETROLEUM EQUIPMENT & TECHNOLOGIES CO., LTD., Yantai (CN)

(72) Inventors: Rikui Zhang, Yantai (CN); Xiance Li, Yantai (CN); Xincheng Li, Yantai (CN); Chunqiang Lan, Yantai (CN); Yipeng Wu, Yantai (CN); Zhuqing Mao, Yantai (CN); Sheng Chang, Yantai (CN); Xiaolei Ji, Yantai (CN)

(21) Appl. No.: 16/838,802

(22) Filed: Apr. 2, 2020

(30) Foreign Application Priority Data
Sep. 20, 2019 (CN) 201910894306.9

(51) Int. Cl. B62D 59/02; F01D 25/30

(52) U.S. Cl. CPC B62D 59/02; F02C 7/045; F01D 25/30

(57) ABSTRACT

The present invention discloses a turbine fracturing semi-trailer, the turbine fracturing semi-trailer including a semi-trailer body, a turbine engine, a reduction gearbox, a power connection device and a plunger pump, wherein the turbine engine, the reduction gearbox, the power connection device and the plunger pump are disposed on the semi-trailer body, the output end of the turbine engine is connected to the reduction gearbox, the reduction gearbox and the plunger pump are connected through the power connection device in a transmission way. Beneficial effects: A transmission output center line of the turbine engine, a transmission input center line of the reduction gearbox, a transmission output center line of the reduction gearbox, a transmission input center line of the plunger pump, an exhaust output center line of the turbine engine, and an exhaust input center line of the exhaust piping are set in a straight line to avoid excessive transmission loss, thus ensuring efficient transmission performance. The semi-trailer is small in size, with low weight, low use cost, and low risk of failure.

### TECHNICAL FIELD

The present invention relates to the field of oil and gas field operations, and specifically to a turbine fracturing semi-trailer.

### BACKGROUND

In the working sites of fracturing in oil and gas fields all over the world, the driving modes for fracturing equipment mainly include the following two ways:

One driving mode is diesel engine driven, specifically a diesel engine is connected to a transmission through a transmission shaft to drive the fracturing plunger pump to work. In other words, a diesel engine is used as the power source, a transmission and a transmission shaft are used as the transmission devices, and a fracturing plunger pump is used as the actuating element.

This configuration mode has the following disadvantages:

(1) Large volume and heavy weight: When a diesel engine drives a transmission to drive a fracturing plunger pump through a transmission shaft, a large volume is occupied, a heavy weight is involved, the transportation is restricted, and the power density is low;

(2) Environmental problems: During operations on a well site, the fracturing equipment driven by the diesel engine would generate engine waste gas pollution and noise pollution. The noise exceeding 105 dBA will severely affect the normal life of nearby residents;

(3) Cost inefficiency: The fracturing equipment driven by the diesel engine requires relatively high initial purchase costs and incurs high fuel consumption costs for unit power during operation, and the engine and the transmission also require very high routine maintenance costs.

The other driving mode is electric drive fracturing, specifically an electric motor is connected to a transmission shaft or a coupling to drive the fracturing plunger pump to work. In other words, an electric motor is used as the power source, a transmission shaft or a coupling is used as the transmission device, and a fracturing plunger pump is used as the actuating element.

Although the electric drive fracturing has many advantages itself, the power supply on fracturing well sites is the prerequisite for implementation of the electric drive fracturing. Generally, it is difficult to supply power for the fracturing well sites in that the power capacity on the well sites is too small to drive the whole fracturing unit, or there are not any power networks at all on the well sites. Therefore, in common electric drive fracturing sites, generators are generally used to generate electricity. The most economical generation fuel is natural gas, but the users employing natural gas need to rent or purchase gas generators. For a fracturing well site without power networks, the power of the gas generator sets need up to at least 30 MW. Purchasing such high-power gas generator sets is a great investment for customers. More importantly, in actual work progress, the accidental shutdown of the gas generator sets would cause the breakdown of the whole electrical fracturing unit, thus seriously affecting the working quality, even causing work accidents possibly.

Therefore, it is an urgent need for a new fracturing equipment to solve the disadvantages of the above existing diesel engine-driven fracturing and electric drive fracturing, thus better satisfying the demands on the oil and gas field fracturing market globally.

### SUMMARY

To overcome the deficiencies in the prior art, an objective of the present invention is to provide a turbine fracturing semi-trailer, wherein a turbine engine, a reduction gearbox, a transmission mechanism and a plunger pump are connected in a straight line along the transmission direction of power to avoid excessive transmission loss, thus ensuring efficient transmission performance. The turbine engine itself has the advantages of small size, light weight and high power density. For the same outline dimensions and weights, the unit power of the turbine fracturing equipment is more than two times of that of conventional diesel engine fracturing equipment. The turbine engine can use 100% natural gas as the fuel directly, greatly reducing the use-cost compared to the diesel consumption in diesel engine drive and the investment on gas generator sets in electric drive fracturing equipment. Meanwhile, the turbine fracturing equipment are usually operated with the plunger pumps drived one-to-one, unlike in electric drive fracturing equipment, a single high-power gas generator set is used to drive multiple plunger pumps. That is to say, a turbine fracturing equipment is employed to distribute the failure risks of single high-power gas generator onto each turbine fracturing equipment, avoiding that the failure of single gas generating equipment causes the risk of breakdown of the whole set of fracturing equipment.

The objective of the present invention is achieved by the following technical measures: a turbine fracturing semi-trailer, including a semi-trailer body, a turbine engine, a reduction gearbox, a transmission mechanism and a plunger pump, wherein the turbine engine, the reduction gearbox, the transmission mechanism and the plunger pump are disposed on the semi-trailer body, an output end of the turbine engine is connected to the reduction gearbox, the reduction gearbox and the plunger pump are connected through a transmission mechanism in a transmission way.

Further, the turbine engine is provided with an exhaust system disposed on an opposite side of the reduction gearbox, the exhaust system includes an exhaust silencer and an exhaust piping, the exhaust silencer is communicated with an exhaust port of the turbine engine through the exhaust piping.

Further, the exhaust system, the turbine engine, the reduction gearbox, the transmission mechanism and the plunger pump are disposed in a straight line along the transmission direction of power.

Further, an air intake system is disposed on the semi-trailer body, the air intake system includes an air intake filter, an air intake silencer and an air intake piping, one end of the air intake silencer is connected to the air intake filter, the other end of the air intake silencer is connected to the air intake piping, and the other end of the air intake piping is communicated with an air intake port of the turbine engine.

Further, the power of the plunger pump is 5000 hp or above.

Further, the transmission mechanism is a transmission shaft or a coupling.

Further, the number of axles of the semi-trailer is 3 or above.

Further, a hydraulic power unit is disposed on a gooseneck of the semi-trailer body, the hydraulic power unit is used to drive the hydraulic system on the turbine fracturing semi-trailer.

Further, the hydraulic power unit is driven by a diesel engine or driven by an electric motor.

Further, a cooling system is disposed on a gooseneck of the semi-trailer body, the cooling system cools oils used on the turbine fracturing semi-trailer.

Compared with the prior art, the beneficial effects of the present invention are as follows: the turbine engine, the reduction gearbox, the transmission mechanism and the plunger pump are connected in a straight line along the transmission direction of power to avoid excessive transmission loss, thus ensuring efficient transmission performance. The turbine engine itself has the advantages of small size, light weight and high power density. For the same outline dimensions and weights, the unit power of the turbine fracturing equipment is more than two times of that of conventional diesel engine fracturing equipment. The turbine engine can use 100% natural gas as the fuel directly, greatly reducing the use-cost compared to the diesel consumption in diesel engine drive and the investment on gas generator sets in electric drive fracturing equipment. Meanwhile, the turbine fracturing equipment is usually operated with the plunger pumps drived one-to-one, unlike in electric drive fracturing equipment, a single high-power gas generator set is used to drive multiple plunger pumps. That is to say, a turbine fracturing equipment is employed to distribute the failure risks of single high-power gas generator onto each turbine fracturing equipment, avoiding that the failure of single gas generating equipment causes the risk of breakdown of the whole set of fracturing equipment.

The present invention will be described in detail below with reference to the accompanying drawings and specific implementations.

### BRIEF DESCRIPTION OF THE DRAWINGS

FIG. 1 is a schematic structural diagram of the present invention.

Wherein, 1. cooling system; 2. hydraulic power unit; 3. semi-trailer body; 4. exhaust silencer; 5. exhaust piping; 6. air intake system; 7. turbine engine; 8. reduction gearbox; 9. transmission shaft; and 10. plunger pump.

### DESCRIPTION OF THE EMBODIMENTS

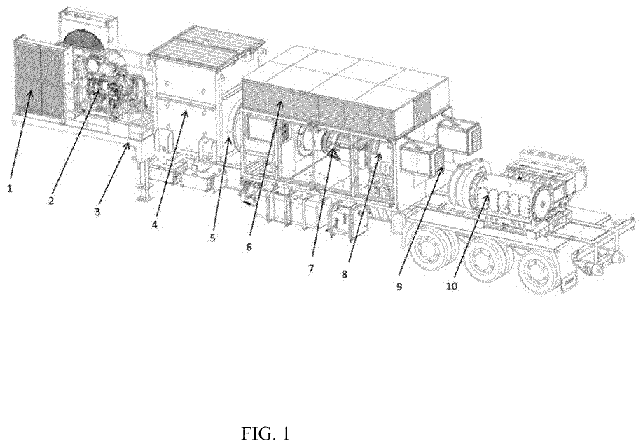

As shown in FIG. 1, a turbine fracturing semi-trailer, including a semi-trailer body 3, a turbine engine 7, a reduction gearbox 8, a transmission mechanism and a plunger pump 10, wherein the turbine engine 7 is the power source of the power transmission system of the entire semi-trailer; the turbine engine 7, the reduction gearbox 8, the transmission mechanism and the plunger pump 10 are disposed on the semi-trailer body 3; the semi-trailer body 3 is also provided with components such as battery wires, a fuel tank, a lubricating oil tank, and a hydraulic oil tank, thus providing oil and support for the mounted components such as the turbine engine 7, the reduction gearbox 8, and the plunger pump 10; an output end of the turbine engine 7 is connected to the reduction gearbox 8, the reduction gearbox 8 and the plunger pump 10 are connected through a transmission mechanism in a transmission way. The reduction gearbox 8 is used to slow down and increase the torque of the power output of the turbine engine 7, and then drive the plunger pump 10 to work through a transmission mechanism.

The turbine engine 7 is provided with an exhaust system disposed on an opposite side of the reduction gearbox 8, the exhaust system includes an exhaust silencer 4 and an exhaust piping 5, the exhaust silencer 4 is communicated with an exhaust port of the turbine engine 7 through the exhaust piping 5. The exhaust piping 5 is used to direct the exhaust of the turbine engine 7 into the exhaust silencer 4, and the exhaust silencer 4 can reduce the exhaust noise.

The exhaust system, the turbine engine 7, the reduction gearbox 8, the transmission mechanism and the plunger pump 10 are disposed in a straight line along the transmission direction of power. The turbine engine 7, the reduction gearbox 8, the transmission mechanism and the plunger pump 10 are connected in a straight line along the transmission direction of power to avoid excessive transmission loss, thus ensuring efficient transmission performance. Moreover, such a configuration can lower the height of center of gravity of the equipment on the semi-trailer body for convenience of transportation. The turbine engine 7 itself has the advantages of small size, light weight and high power density. For the same outline dimensions and weights, the unit power of the turbine fracturing equipment is more than two times of that of conventional diesel engine fracturing equipment. The turbine engine 7 can use 100% natural gas as the fuel directly, greatly reducing the use-cost compared to the diesel consumption in diesel engine drive and the investment on gas generator sets in electric drive fracturing equipment. Of course, the turbine engine 7 also can use 100% fuel oil as the fuel, while natural gas is preferably used, which can reduce the fuel cost much more than fuel oil. Meanwhile, the turbine fracturing equipment is usually operated with the plunger pumps 10 drived one-to-one, unlike in electric drive fracturing equipment, a single high-power gas generator set is used to drive multiple plunger pumps 10. That is to say, a turbine fracturing equipment is employed to distribute the failure risks of single high-power gas generator onto each turbine fracturing equipment, avoiding that the failure of single gas generating equipment causes the risk of breakdown of the whole set of fracturing equipment.

An air intake system 6 is disposed on the semi-trailer body 3, the air intake system 6 includes an air intake filter, an air intake silencer and an air intake piping, one end of the air intake silencer is connected to the air intake filter, the other end of the air intake silencer is connected to the air intake piping, and the other end of the air intake piping is communicated with an air intake port of the turbine engine 7.

The power of the plunger pump 10 is 5000 hp or above; the greater the power of the plunger pump 10 is, the more suitable for lone-time and high-load continuous operation conditions.

The transmission mechanism is a transmission shaft 9 or a coupling.

The number of axles of the semi-trailer body 3 is 3 or above, to ensure an adequate bearing capacity.

A hydraulic power unit 2 is disposed on a gooseneck of the semi-trailer body 3, the hydraulic power unit 2 is used to drive the hydraulic system on the turbine fracturing semi-trailer. The hydraulic system includes a hydraulic pump, a hydraulic motor, various valves, a hydraulic oil tank, a hydraulic oil radiator, etc. (The main role of the hydraulic system is to drive the fuel pump of the turbine engine 7, the starting motor of the turbine engine 7, the power end lubrication system of the plunger pump 10, the lubrication system of the reduction gearbox 8, various oil radiators and the like).

The hydraulic power unit 2 is a diesel engine or an electric motor.

A cooling system 1 is disposed on a gooseneck of the semi-trailer body 3, the cooling system 1 cools oils used on the turbine fracturing semi-trailer. The used oils include engine oil and hydraulic oil for the turbine engine 7, lubricating oil for the plunger pump 10, lubricating oil for the reduction gearbox 8, and the like.

It will be appreciated to persons skilled in the art that the present invention is not limited to the foregoing embodiments, which together with the context described in the specification are only used to illustrate the principle of the present invention. Various changes and improvements may be made to the present invention without departing from the spirit and scope of the present invention. All these changes and improvements shall fall within the protection scope of the present invention. The protection scope of the present invention is defined by the appended claims and equivalents thereof.

1. A turbine fracturing semi-trailer, wherein the turbine fracturing semi-trailer comprises a semi-trailer body, a turbine engine, a reduction gearbox, a transmission shaft or coupling and a plunger pump, the turbine engine, the reduction gearbox, the transmission shaft or coupling and the plunger pump are disposed on the semi-trailer body, an output end of the turbine engine is connected to the reduction gearbox, wherein the reduction gearbox is disposed outside of the plunger pump and connected with the plunger pump through the transmission shaft or coupling in a transmission way.

2. The turbine fracturing semi-trailer according to claim 1, wherein the turbine engine is provided with an exhaust system disposed on an opposite side of the reduction gearbox, the exhaust system comprises an exhaust silencer and an exhaust piping, the exhaust silencer is communicated with an exhaust port of the turbine engine through the exhaust piping.

3. The turbine fracturing semi-trailer according to claim 2, wherein the exhaust system, the turbine engine, the reduction gearbox, the transmission shaft or coupling and the plunger pump are disposed in a straight line.

4. The turbine fracturing semi-trailer according to claim 1, wherein an air intake system is disposed on the semi-trailer body.

5. The turbine fracturing semi-trailer according to claim 1, wherein the plunger pump has a power of at least 5000 hp.

6. (canceled)

7. The turbine fracturing semi-trailer according to claim 1, wherein the semi-trailer has at least 3 axles.

8. The turbine fracturing semi-trailer according to claim 1, wherein a hydraulic power unit is disposed on a gooseneck of the semi-trailer body, the hydraulic power unit is used to drive a hydraulic system on the turbine fracturing semi-trailer.

9. The turbine fracturing semi-trailer according to claim 8, wherein the hydraulic power unit is driven by a diesel engine or driven by an electric motor.

10. The turbine fracturing semi-trailer according to claim 1, wherein a cooling system is disposed on a gooseneck of the semi-trailer body, the cooling system cools oils used on the turbine fracturing semi-trailer.
